(19) United States
(12) Patent Application Publication
(10) Pub. No.: US 2026/0073039 A1
(43) Pub. Date: Mar. 12, 2026

(54) ENDPOINT THREAT MITIGATION BASED ON RUNTIME TELEMETRY DATA

(71) Applicant: Spektion, Inc., Dripping Springs, TX (US)

(72) Inventors: Joseph SILVA, Dripping Springs, TX (US); Joshua SKORICH, Wimberley, TX (US); Julien MALADRIE, Round Rock, TX (US); Doug SHEPHERD, Farragut, TN (US); Robert ROBERSON, Seattle, WA (US); Brandon FERRUA, Driftwood, TX (US)

(73) Assignee: Spektion, Inc., Dripping Springs, TX (US)

(21) Appl. No.: 19/326,337

(22) Filed: Sep. 11, 2025

Related U.S. Application Data
(60) Provisional application No. 63/694,047, filed on Sep. 12, 2024.

(51) Int. Cl. G06F 21/54; G06F 12/02; G06F 21/55; G06F 21/57

(52) U.S. Cl. CPC G06F 21/54; G06F 12/0253; G06F 21/554; G06F 21/577; G06F 2221/033

(57) ABSTRACT

Disclosed herein are methods and systems for improving endpoint device security. An agent deployed to the endpoint device may inject monitoring code into a program during runtime of the program. The monitoring code instructs the program to generate runtime telemetry data. The agent may detect behavior indicative of a security risk based on the runtime telemetry data. The agent may automatically perform at least one remedial action of a plurality of remedial actions, wherein the plurality of remedial actions comprises: notifying a user of the endpoint device of the behavior indicative of the security risk, terminating the program, blocking one or more functions of the program, and reporting the behavior indicative of the security risk to a server system.

### CROSS-REFERENCE TO RELATED APPLICATIONS

This application claims the benefit of U.S. Provisional Application 63/694,047, filed Sep. 12, 2024, the entire contents of which are incorporated herein by reference for all purposes.

### FIELD

The present disclosure relates generally to cybersecurity and, more specifically, to assessing applications executed on endpoints at runtime.

### BACKGROUND

Endpoint protection is a component of the cybersecurity strategy of most governments and medium to large business entities. Endpoint protection involves protecting computing systems and other network-connected devices of an entity from threats and vulnerabilities (e.g., that may be exploited by a malicious actor).

Traditional endpoint security solutions have primarily focused on signature-based detection, which involves identifying known threats by comparing program code, files, etc. against a database of signatures for previously recognized and cataloged malware or vulnerabilities. In other words, signature-based approaches are inherently reactive and unable to detect new or modified threats that have not been previously identified and cataloged. The security benefit afforded by such solutions to new threats often amounts to no more than fulfillment of a checkbox on a list of best practices. Moreover, signature-based solutions can also negatively impact endpoint performance. Active scanning and monitoring techniques, let alone scheduled scans, may require substantial system resources, potentially leading to decreased performance and productivity. Nevertheless, even with the above-noted and other shortcomings, reliance (and overreliance) on such security solutions is commonplace.

### SUMMARY

The following is a non-exhaustive listing of some aspects of the present techniques. These and other aspects are described in the following disclosure.

Some aspects include computer implemented processes or methods for improving endpoint security.

In some aspects, systems, processes, and methods for improving endpoint security can include operations for obtaining runtime telemetry data indicative of software behavior. In some aspects, runtime telemetry data may be obtained with a client-side monitoring component, or agent, executing on an endpoint. In some aspects, runtime telemetry data may be obtained by a server system from a plurality of agents executing on a respective plurality of endpoints. In some aspects, runtime telemetry data indicative of software behavior corresponds to a selected software product and/or type of software product and can be obtained from a first plurality of agents that have executed and/or are executing one or more processes associated with the selected software product or type of software product.

In some aspects, systems, processes, and methods for improving endpoint security can include operations performed by a client-side monitoring component, or agent, which is provided to an endpoint for a client-side role in cataloging software on the endpoint. An endpoint and each of a plurality of other endpoints may execute a respective agent instance. When an agent is activated on an endpoint it may form an initial catalogue of different software that is present on or installed to the respective endpoint. The agent may report the initial catalog to a server system. The agent may listen for (e.g., detect and/or monitor) events indicative of changes to the different software that is present or installed to the respective endpoint and communicate one or more catalog updates describing those changes to the server system and/or another server system.

In some aspects, systems, processes, and methods for improving endpoint security can include operations performed by a client-side monitoring component, or agent, which analyzes software behavior on endpoints at runtime. An agent may detect execution events corresponding to software selected for monitoring. In response to detecting the execution event, the agent may inject a monitor for collecting runtime telemetry from a process (or processes) corresponding to the execution event. The agent may analyze runtime telemetry data collected by monitors and perform a variety of operations based on results of the analysis. For example, in response to detecting unwanted behavior based on telemetry data, a result or results of the analysis may indicate one or more processes or related processes to be terminated. The agent may terminate the indicated process (or processes). Additionally or alternatively, a result or results of the analysis may also indicate whether one or more ended or other processes should be prevented from executing in the future on the endpoint by the agent. The agent may generate a risk score for the program based on the runtime telemetry data. The risk score may be updated in response to changes in runtime behavior of the program over time. The agent may log information including or more of telemetry data, determined results, and operations performed in response to results and report some or all of the logged information to the server system and/or another server system. The server system may obtain log information from a plurality of agents executing on a respective plurality of endpoints. Some or all of the log information may be reported by agents temporally proximate to collection of runtime telemetry data on which respective log information is based such that the server system or another server system may analyze behavior of selected software across a set of endpoints proximate in time to or while the selected software is executed by the set of endpoint.

In some aspects, systems, processes, and methods for improving endpoint security can include operations performed by a server system in support of endpoint devices. The endpoint devices may execute a client-side component, like an agent, which communicates with the server system. In some aspects, the server system receives a selection of software indicated on a catalogue of software reported by an endpoint. For example, the server system may receive a selection of software from a user, like an administrator, with respect to the endpoint or a set of endpoints of which the endpoint is a member. In some examples, all or some of the selections of software may be determined by the server system based on a policy, which may be an endpoint policy selected from among a plurality of different endpoint policies, such as based on an identifier associated with the reporting endpoint. The server system may transmit or cause information about the selections to be transmitted to the corresponding endpoint. Examples of such information may indicate one or more of which software to monitor, which software not to monitor, and which software (or functions thereof) to prevent from executing. The server system and/or another server system may receive and analyze log information corresponding to runtime behavior of software selected for monitoring on endpoints. The server system may, based on the log information, mitigate (e.g., prevent or limit the severity of) an attack to exploit monitored software based on one or more of current runtime telemetry data, previously collected runtime telemetry data from execution of that software on that endpoint or other instances of that software on other endpoints, and/or contemporaneously collected runtime telemetry data from execution of that software on other endpoints. The server may generate a risk score for the program based on the runtime telemetry data. The risk score may be updated in response to changes in runtime behavior of the program over time.

Some aspects include a tangible, non-transitory, machine-readable medium (e.g., a computer-readable medium) storing instructions that when executed by a data processing apparatus cause the data processing apparatus to perform one or more operations included in the above-mentioned processes or methods.

Some aspects include a system, including: one or more computing devices with one or more processors; the one or more computing devices including at least one memory storing instructions that when executed by the processors cause the processors to effectuate operations included in the above-mentioned processes or methods.

An exemplary method for providing endpoint security comprises: injecting, by an agent deployed to an endpoint device, a monitoring code into a program during runtime of the program, wherein the monitoring code instructs the program to generate runtime telemetry data; detecting behavior indicative of a security risk based on the runtime telemetry data; and automatically performing at least one remedial action of a plurality of remedial actions, wherein the plurality of remedial actions include: notifying a user of the endpoint device of the behavior indicative of the security risk; terminating the program; blocking one or more functions of the program; and reporting the behavior indicative of the security risk to a server system.

In some embodiments, the method further comprises transmitting, by the agent, the runtime telemetry data to the server system. In some embodiments, injecting the monitoring code includes allocating memory within the program and installing the monitoring code in the allocated memory. In some embodiments, the method further comprises freeing the memory within the program after the monitoring code has been executed. In some embodiments, the agent selectively monitors the program based on a list of monitored programs stored on the endpoint device. In some embodiments, the agent injects the monitoring code into the program in response to detecting a predetermined event associated with the program. In some embodiments, the predetermined event includes a launch or installation of the program.

In some embodiments, detecting the behavior indicative of the security risk includes applying a set of rules to the runtime telemetry data. In some embodiments, the agent updates the set of rules based on instructions received from at least one of the server system or the user of the endpoint device. In some embodiments, the behavior indicative of the security risk corresponds to at least one of unauthorized access attempts, unauthorized communication attempts, installation of software, or removal of software. In some embodiments, detecting the behavior indicative of the security risk includes analyzing the runtime telemetry data within a selected time window. In some embodiments, the agent at least partially anonymizes the runtime telemetry data prior to reporting the behavior indicative of the security risk to the server system. In some embodiments, the agent continuously monitors the program for changes in runtime behavior over time.

In some embodiments, the method further comprises displaying, via a user interface, information describing the behavior indicative of the security risk.

In some embodiments, the user interface is further configured to display recommended remedial actions or compensating controls associated with the behavior indicative of the security risk.

In some embodiments, the method further comprises generating a risk score for the program based on the runtime telemetry data.

In some embodiments, the risk score generated for the program is updated in response to changes in runtime behavior of the program over time.

In some embodiments, the runtime telemetry data includes at least one of: information about function calls executed by the program; data loaded, requested, or operated on by functions or processes of the program; system-level APIs, libraries, or services used by the program; executable code or components loaded by the program; and processes of the program.

An exemplary system for providing endpoint security comprises: one or more processors; one or more memories; and one or more programs, wherein the one or more programs are stored in the one or more memories and configured to be executed by the one or more processors, the one or more programs including instructions for: injecting, by an agent deployed to an endpoint device, a monitoring code into a program during runtime of the program, wherein the monitoring code instructs the program to generate runtime telemetry data; detecting behavior indicative of a security risk based on the runtime telemetry data; and automatically performing at least one remedial action of a plurality of remedial actions, wherein the plurality of remedial actions include: notifying a in user of the endpoint device of the behavior indicative of the security risk; terminating the program; blocking one or more functions of the program; and reporting the behavior indicative of the security risk to a server system.

In some embodiments, the one or more programs further include instructions for transmitting, by the agent, the runtime telemetry data to the server system. In some embodiments, injecting the monitoring code includes allocating memory within the program and installing the monitoring code in the allocated memory. In some embodiments, the one or more programs further include instructions for including freeing the memory within the program after the monitoring code has been executed. In some embodiments, the agent is configured to selectively monitor the program based on a list of monitored programs stored on the endpoint device. In some embodiments the agent is configured to inject the monitoring code into the program in response to detecting a predetermined event associated with the program. In some embodiments, the predetermined event includes a launch or installation of the program.

In some embodiments, detecting the behavior indicative of the security risk includes applying a set of rules to the runtime telemetry data. In some embodiments, the agent is further configured to update the set of rules based on instructions received from at least one of the server system or the user of the endpoint device. In some embodiments, the behavior indicative of the security risk corresponds to at least one of unauthorized access attempts, unauthorized communication attempts, installation of software, or removal of software. In some embodiments, detecting the behavior indicative of the security risk includes analyzing the runtime telemetry data within a selected time window. In some embodiments, the agent is configured to at least partially anonymize the runtime telemetry data prior to reporting the behavior indicative of the security risk to the server system. In some embodiments, the agent is configured to continuously monitor the program for changes in runtime behavior over time. In some embodiments, the one or more programs further include instructions for displaying, via a user interface, information describing the behavior indicative of the security risk. In some embodiments, the user interface is further configured to display recommended remedial actions or compensating controls associated with the behavior indicative of the security risk. In some embodiments, the one or more programs further include instructions for generating a risk score for the program based on the runtime telemetry data. In some embodiments, the risk score generated for the program is updated in response to changes in runtime behavior of the program over time. In some embodiments, the runtime telemetry data includes at least one of: information about function calls executed by the program; data loaded, requested, or operated on by functions or processes of the program; system-level APIs, libraries, or services used by the program; executable code or components loaded by the program; and processes of the program.

An exemplary non-transitory computer-readable storage medium stores one or more programs for providing endpoint security, the one or more programs including instructions, which when executed by one or more processors of an endpoint device, cause the endpoint device to: inject, by an agent deployed to the endpoint device, a monitoring code into a program during runtime of the program, wherein the monitoring code instructs the program to generate runtime telemetry data; detect behavior indicative of a security risk based on the runtime telemetry data; and automatically perform at least one remedial action of a plurality of remedial actions, wherein the plurality of remedial actions include: notifying a user of the endpoint device of the behavior indicative of the security risk; terminating the program; blocking one or more functions of the program; and reporting the behavior indicative of the security risk to a server system.

In some embodiments, injecting the monitoring code includes allocating memory within the program and installing the monitoring code in the allocated memory. In some embodiments, the endpoint device is caused to transmit, by the agent, the runtime telemetry data to the server system. In some embodiments, the endpoint device is caused to free the memory within the program after the monitoring code has been executed. In some embodiments, the agent selectively monitors the program based on a list of monitored programs stored on the endpoint device. In some embodiments, the agent is configured to inject the monitoring code into the program in response to detecting a predetermined event associated with the program. In some embodiments, the predetermined event includes a launch or installation of the program.

In some embodiments, detecting the behavior indicative of the security risk includes applying a set of rules to the runtime telemetry data. In some embodiments, the agent is further configured to update the set of rules based on instructions received from at least one of the server system or the user of the endpoint device. In some embodiments, the behavior indicative of the security risk corresponds to at least one of unauthorized access attempts, unauthorized communication attempts, installation of software, or removal of software. In some embodiments, detecting the behavior indicative of the security risk includes analyzing the runtime telemetry data within a selected time window. In some embodiments, the agent is configured to at least partially anonymize the runtime telemetry data prior to reporting the behavior indicative of the security risk to the server system. In some embodiments, the agent is configured to continuously monitor the program for changes in runtime behavior over time. In some embodiments, the endpoint device is caused to generate a risk score for the program based on the runtime telemetry data. In some embodiments, the risk score generated for the program is updated in response to changes in runtime behavior of the program over time. In some embodiments, the runtime telemetry data includes at least one of: information about function calls executed by the program; data loaded, requested, or operated on by functions or processes of the program; system-level APIs, libraries, or services used by the program; executable code or components loaded by the program; and processes of the program.

### BRIEF DESCRIPTION OF THE FIGURES

The above-mentioned aspects and other aspects of the present techniques will be better understood when the present application is read in view of the following figures in which like numbers indicate similar or identical elements:

FIG. 1 is a block diagram showing an example of a computing environment by which the present techniques for assessing software executed on endpoints at runtime may be implemented, in accordance with at least some disclosed embodiments.

FIG. 2 is a block diagram showing an example of a client-server architecture that may be used for assessing software executed on an example endpoint at runtime within the example computing environment, in accordance with at least some disclosed embodiments.

FIG. 3 is a flow chart showing an example of a process by which an endpoint agent may provision a monitor of a program process within the example computing environment, in accordance with at least some disclosed embodiments.

FIG. 4 is a flow chart showing an example of a process by which an endpoint agent may be hardened against potential threats within the example computing environment, in accordance with at least some disclosed embodiments.

FIG. 5 is a diagram showing an example of a process by which an endpoint agent may selectively monitor program processes, in accordance with at least some disclosed embodiments.

FIG. 6 is a block diagram showing an example of a computing device by which the present techniques may be implemented, in accordance with at least some disclosed embodiments.

FIG. 7 is an example embodiment of a user interface by which some examples of results and information determined based on runtime telemetry data may be displayed, in accordance with at least some disclosed embodiments.

FIG. 8A is an example embodiment of a first portion of a user interface by which some examples of results and information determined based on runtime telemetry data may be displayed, in accordance with at least some disclosed embodiments.

FIG. 8B an example embodiment of a second portion of the user interface shown in FIG. 8A by which some examples of results and information determined based on runtime telemetry data may be displayed, in accordance with at least some disclosed embodiments.

FIG. 9 is a flowchart of an example method for a method for providing endpoint security.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the field of cybersecurity. Indeed, the inventors wish to emphasize the difficulty of recognizing those problems that are nascent and will become much more apparent in the future should trends in industry continue as the inventors expect. Further, because multiple problems are addressed, it should be understood that some embodiments may be problem-specific, and not all embodiments address every problem with approaches described herein or provide every benefit described herein. That said, improvements that solve various permutations of these problems are described below.

Software supply chain attacks are becoming an increasingly large risk to business and government entities. The attack surface of a software supply chain (e.g., the points where an unauthorized user can try to enter data or extract data from an environment) available to a malicious actor seeking to exploit computing systems of such entities is typically multi-dimensional and, in general, grows in each dimension. The attack surface of an entity may increase significantly as an ever-growing number of software products are used on computing devices of the entity, which includes, but is not limited to endpoint devices. Similarly, the attack surface of those software products is often increasing over time due to increases of complexity or interoperability with other software products.

Managing the growth of these attack surfaces is challenging for entities because it is beneficial to provide employees with the agency to use new, updated, or even legacy software products as needed to best perform their roles, increase productivity, and/or otherwise to stay up to date with technological trends. New software products are often permitted on entity computing systems without disrupting existing (or legacy) software products already used. This software creep on computing systems of an entity is often viewed as unavoidable to a certain degree, and thus, frequently ignored.

The concept of software creep may extend to other areas, such as individual software products themselves. For example, developers often add new or updated features to their software products to distinguish them from competing products. The addition of such new features or otherwise increasing the utility of existing features within a software product is often reliant on use of an increasing number of components, libraries, and processes, among other potential attack vectors available to malicious actors, like software runtime environments (e.g., that afford the execution of extensions, macros, or other code).

These factors, among others, can lead to an ever-expanding attack surface available to malicious actors that is not addressed by existing techniques, such as an overreliance on reactive signature-based security solutions. Not unlike signature-based security solutions, entity decision making governing use of software products is all too often reactive because there is a lack of information pertaining to actual risk, as well as increases and decreases in the risk associated with different software products over time.

In many instances, corporate and government entity decision making concerning whether to run a software product on computing devices of the entity is based on a perceived degree of risk associated with the software, which often differs from actual risk. Perceived risk of a software product is generally reactive and all too often falsely informed based on irrelevant, out of date, and/or biased views on information about security issues in the software product or other software products from the same developer. For example, perceived risk is often based on decision maker views on whether a software product was subject to vulnerabilities that could have been, or were, exploited by a malicious actor in the past, as well as the severity of those past vulnerabilities. Reactive approaches too often miss the mark because they fail to account for current software product performance and trajectory of software product performance.

For example, a software product perceived to have low risk may become high risk because the developer neglects to update the software product based on current best practices and/or introduces a new vulnerability by addition of new features. Failing to proactively address an increasing security risk of a software product can leave an entity susceptible to software supply chain attacks that exploit a vulnerability in that software product. In many cases, entities using the software product lack insight into the increased potential for vulnerabilities that are inherently unknown to signature-based solutions.

Conversely, an entity may ignore a potentially useful or competing software product because it is perceived as being high risk by the entity, such as because of a prior vulnerability in that software product or in another software product from the developer. Since discovery of that vulnerability, the developer may have updated and improved the software product or their practices, e.g., hardening their software products to mitigate the potential for vulnerabilities and limit their potential severity. Accordingly, that software product may now constitute a low risk or lower risk than other competing software options, but the entity may fail to act because of existing bias and a lack of information to inform the decision.

Some enterprises and more sophisticated mid-market organizations are becoming increasingly cognizant of the need to mitigate risks associated with supply chain attacks on software products, especially in the face of successful high-profile data breaches involving exploits of vulnerabilities in commonly used third-party software products. However, there is a lack of information available to make informed decisions that definitively reduce such risks.

Risk conscious entities often leverage multiple different product and expert-based solutions to form a limited assessment of third-party software products and tools. Canonical examples may include vendor risk monitoring, vulnerability scanners, and software bill of material (SBOM) analysis of a software product, each of which may be deemed by an entity to inform some aspect of an internal risk assessment associated with use of the software product. Some example shortcomings of these conventional techniques include:
a. Third-party vendor risk assessment products solely evaluate vendor attributes that often have little-to-no correlation to the security of a specific software product at issue that a vendor sells. These risk assessment solutions are also incapable of addressing open source and internally developed software.
b. Vulnerability scanners for software are focused on identifying common vulnerabilities and exposures (CVEs). These scanners, like signature-based scanners, are reactive. They are prone to missing risks not cataloged in existing CVEs and software products that lack scrutiny for vulnerabilities.
c. SBOM analysis solutions are limited in that they fail to contextualize risks. In many cases, a vulnerability of a component included within a bill of materials does not present an inherent risk because the component is not used in an exploitable way. SBOMs are often more informative to development teams tasked with maintenance of a variety of software products including similar or like components than entities using a given one of those software products.

The above techniques (whether employed alone or in combination) all too often fall short of providing a full picture of potential risk associated with use of a software product (which is not to suggest that any technique described above is disclaimed, or that such techniques do not synergize with other techniques described herein). For example, vulnerability scanners for software (examples of which include Qualys, Tenable, Rapid7) are focused on CVEs, and detect threats with greater lag and/or latency compared to detections afforded by the present techniques. Specifically, conventional vulnerability scanners miss many risks not captured in CVEs or software not scrutinized for vulnerabilities that can be detected and mitigated by the present techniques. However, best security practices in some contexts may still use conventional vulnerability scanners for purposes other than real-time threat mitigation in combination with the present techniques. In another example, in contrast to SBOM solutions, the present techniques provide better visibility into actual risk. For example, the present techniques may provide a tiered detection and analysis approach that may detect and analyze insecure behavior from software runtime on individual endpoints, a collection of endpoints of an entity, or endpoints across different entities.

Some embodiments and techniques disclosed herein mitigate one or more of the aforementioned issues (among others) with a proactive, entity-specific approach to endpoint security. For example, embodiments disclosed herein may obtain telemetry data (e.g., attributes) pertaining to execution of a software product at runtime (including, but not limited to, context within which function calls are made and other attributes of execution) and track changes in how the software product executes over time. Embodiments disclosed herein may analyze telemetry data to determine software behavioral factors indicative of evolution of risk of different software or functions thereof. Embodiments disclosed herein may afford comparative analyses of behavioral factors, attributes of software execution, and other metrics across computing systems of an entity. Optionally, the embodiments disclosed herein can provide such comparative analyses among and relative to other entities, such as via anonymized reporting and analysis of that information by a third party provider of endpoint protections services employing techniques like those described above.

Some embodiments may proactively mitigate available attack surfaces and vectors of attacks that might otherwise be used to exploit endpoints through vulnerabilities in the software they execute. For example, some embodiments described herein may provide improvements in computer security by monitoring the behavior of software programs and their associated processes to detect unauthorized attempts to access credentials or other sensitive data in system memory. This monitoring enables the system to identify and mitigate such attacks in a temporally proximate manner (e.g., in real-time or near real time) thereby reducing the risk of data capture by malicious actors. In some embodiments, monitoring of software programs and their associated processes may detect or intercept instances of unauthorized inter-process communication on an endpoint device, unauthorized communication attempts via interfaces of the endpoint device (e.g., attempts to convey sensitive data to an external device or computing system), unauthorized function calls and the like. Some embodiments described herein may provide improvements in endpoint security within user facing client execution environments (e.g., processes executed within the context of an operating system) that are synergetic with trusted execution environments, like Secure Enclave, ARM TrustZone, or various other trusted platform modules, like those compliant with ISO/IEC 11889 (the contents of which are hereby incorporated by reference), further enhancing endpoint security. Moreover, the techniques described in relation to some of those embodiments for mitigating unauthorized software program behavior may limit or prevent such behavior even in instances where a malicious party has physical access to an endpoint device.

Some embodiments of the disclosed techniques may provide, to endpoints, a client-side monitoring component, like an agent, which may be executed on an endpoint to catalogue the various software present on or installed to the endpoint and monitor a selection of that software when it is executed on the endpoint. Embodiments of the agent may monitor selected software at runtime (e.g., at predetermined events associated with the runtime of the program, including launch, installation, and/or during execution) on endpoints to collect runtime telemetry data corresponding to behavior of that software. Embodiments may mitigate (e.g., prevent or limit the severity of) an attack to exploit the monitored software based on one or more of current runtime telemetry data, previously collected runtime telemetry data from execution of that software on that endpoint or other instances of that software on other endpoints, and/or contemporaneously collected runtime telemetry data from execution of that software on other endpoints. A server-side component may collect and analyze data received from endpoint agents, such as to characterize baseline software behaviors within an entity specific context of how that software is used on those endpoints. In some examples, that data may be anonymized by a server-side component of an entity prior to transmission to a service provider or anonymized by the service provider for a tenant account of the entity and tenant accounts of other entities before analysis. The service provider may analyze software behavior and other data obtained from a plurality of entities to determine and report on broader baseline software behavior across one or more different contexts, behavior of software that differs for different contexts, expected behavior of a software when used within a given context, and other assessments (e.g., a context-relevant software vulnerability risk score) based on software behavior and functionality. Thus, some embodiments implementing techniques like those disclose herein may provide entities with better visibility into actual software vulnerability risks given how telemetry data is collected and analyzed to detect insecure behavior across different use case contexts by different entities.

The disclosed techniques are expected to provide benefits to a broad range of entities and decision makers with varying degrees of technical expertise in the field of cybersecurity for a large number of use cases, some examples of which are described below:
a. Pre-purchase/adoption security evaluation: Risk/vulnerability assessments based on actual runtime software behavior are apt to provide objective information to decision makers and better inform decision on whether to use the software or how the software may be approved for use. Assessment findings may be shared with third party software vendors to identify high/critical security risks that need to be addressed before purchase.
b. Continuous monitoring: Third party risk, vulnerability management, and/or threat detection team reaction latency to (pre-CVE) risks that emerge as software is updated, configuration is changed, or if a software product is being attacked is expected to improve with continuous monitoring of these factors.
c. Mitigating controls: Risk/vulnerability assessment findings may be used to trigger compensating/mitigating control workflows and inform the development and deployment of effective compensating/mitigating control to address the underlying behavioral risks/vulnerabilities.
d. Rationalization/restriction: Score-based risk/vulnerability approaches that lack bias and visualizations for tracking software sprawl, such as after M&As and in environments where users can install their own software, can better inform software discovery and management of software across endpoints. Findings may provide a basis for determining what software should be allowed, removed, or temporarily restricted (e.g., subject to vendor improvements that mitigate flaws).
e. Threat hunting/response: Identification of exploitable software or software exhibiting behavior indicative of a supply chain attack at runtime on endpoints can reduce latency of threat hunting and proactively trigger support follow-on response activities.

The disclosed techniques address the technical problem of inadequate and reactive endpoint security posed by traditional signature-based detection methods, which are limited in their ability to identify new, modified, or context-specific threats. For example, the disclosed techniques provide a technical solution in which an agent can be deployed to endpoint devices to inject monitoring code into a program for monitoring the program during its runtime. For example, the agent can inject the monitoring code into a program in response to detecting a predetermined event associated with the program (e.g., launch, installation, and/or execution of the program).

This agent can collect detailed runtime telemetry data indicative of software behavior, analyze the data using configurable rules, and detect events that may signal security risks-including unauthorized access attempts, unauthorized inter-process communications, unauthorized installation of software, unauthorized removal of software, and/or other suspicious activities. The agent may be configured to automatically perform remedial actions in response to detection of a security risk, such as notifying a user, terminating a program, blocking functions of the program, and reporting to a server system. The provided techniques may enable continuous monitoring, cataloging of software changes, and/or aggregation of telemetry data for broader analysis, thereby providing proactive, context-aware threat mitigation that addresses shortcomings of prior approaches.

The techniques disclosed herein also provide an improvement to the functioning of computers by enhancing their ability to autonomously detect and respond to security threats at runtime, without relying solely on pre-existing threat signatures or manual intervention. By injecting monitoring components directly into program processes, the agent can operate at a privileged level within the execution environment, enabling real-time visibility into program activities such as function calls, API usage, and system interactions. This approach can allow computers to dynamically analyze and respond to evolving threats, including those not previously cataloged, and/or to adapt monitoring criteria based on contextual information and policy updates. The agent's ability to log and store telemetry data locally, report findings to a central server, and/or facilitate continuous risk assessment results in reduced latency for threat detection and response, improved resource utilization, and more effective protection of sensitive data and system integrity.

At least some embodiments disclosed herein may confer one or more of the aforementioned benefits over existing systems, or other benefits, some of which will be self-evident to those of ordinary skill in the art and may remain unstated.

Some embodiments may be implemented in a distributed physical architecture that includes client (e.g., endpoint) computing devices controlled by diverse collections of end users (e.g., more than 10, more than 100, more than 1,000, or more than 10,000 different end users, each using one or more endpoint devices) corresponding to various business or government entities. The techniques herein are also applicable to individual end consumers. In some embodiments, users may operate endpoint computing devices, like a laptop or desktop computer, which a user may access (e.g., log into using credentials) to perform various tasks. Other devices may also be suitable for this purpose, such as tablets, netbooks, smartphones, and the like.

As used herein, the singular forms “a,” “an,” and “the” include the plural reference unless the context clearly dictates otherwise.

The term “software”, as used herein, may alternatively be referred to as an (software/computer) program or application (or executable, and the like) for increased clarity in the description (or claims), such as to more clearly distinguish between different software or instances thereof. As such, use of an alternative term in certain embodiments described herein should not be construed as limiting that embodiment based on (e.g., nuanced) differences or distinctions between such alternative terms, unless those differences are explicitly stated or inherent to that embodiment (e.g., as would be understood by one skilled in the art).

Reference to “about” a value or parameter herein includes (and describes) variations that are directed to that value or parameter per se. For example, description referring to “about X” includes description of “X.”

It is understood that aspects and variations of the invention described herein include “consisting of” and/or “consisting essentially of” aspects and variations.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

The description is presented to enable one of ordinary skill in the art to make and use the invention and is provided in the context of a patent application and its requirements. Various modifications to the described embodiments will be readily apparent to those persons skilled in the art and the generic principles herein may be applied to other embodiments. Thus, the present invention is not intended to be limited to the embodiment shown but is to be accorded the widest scope consistent with the principles and features described herein.

The figures illustrate processes according to various embodiments. In the exemplary processes, some blocks are, optionally, combined, the order of some blocks is, optionally, changed, and some blocks are, optionally, omitted. In some examples, additional steps may be performed in combination with the exemplary processes. Accordingly, the operations as illustrated (and described in greater detail below) are exemplary by nature and, as such, should not be viewed as limiting.

Finally, it is to be understood that features and preferences described in relation to “embodiments” are distinct preferences and are not limited only to that particular embodiment; they may be freely combined with features from other embodiments, where technically feasible, and may form preferred combinations of features. The description is presented to enable one of ordinary skill in the art to make and use the invention and is provided in the context of a patent application and its requirements. Various modifications to the described embodiments will be readily apparent to those persons skilled in the art and the generic principles herein may be applied to other embodiments. Thus, the present invention is not intended to be limited to the embodiment shown but is to be accorded the widest scope consistent with the principles and features described herein.

The entire disclosure of the patents and publications referred in this application are hereby incorporated herein by reference for all purposes. To the extent that any reference incorporated by reference conflicts with the instant disclosure, the instant disclosure shall control.

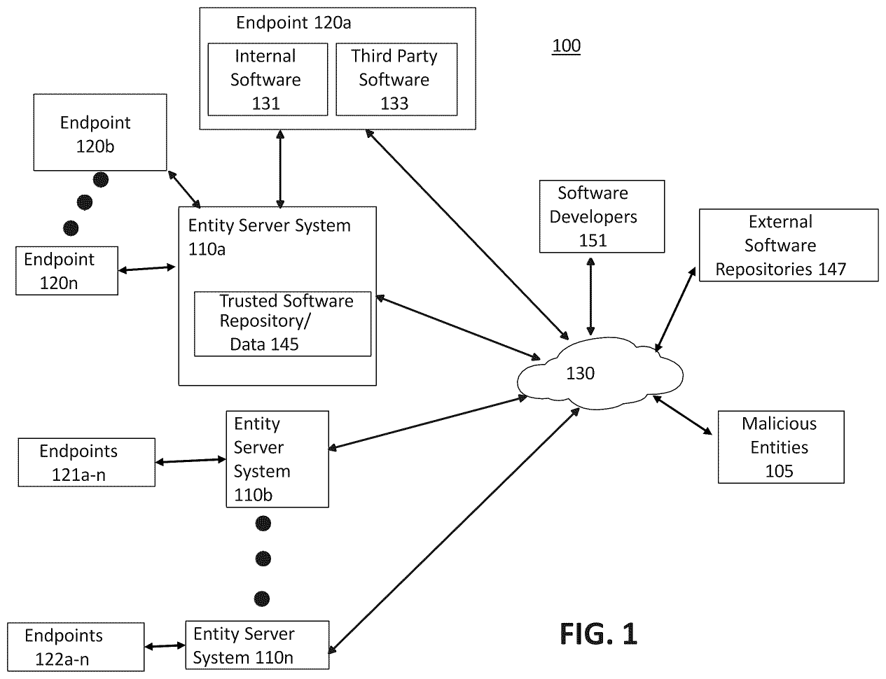

FIG. 1 is a block diagram showing an example of a computing environment 100 within which the present techniques for assessing applications executed on endpoints at runtime may be implemented, in accordance with at least some disclosed embodiments. Depicted within the computing environment 100 are a variety of computing devices and systems that may communicate with one or more other such computing devices and systems over a network 130. In some embodiments, network 130 may be the internet, virtual networks, and/or private networks. In some embodiments, each depicted element may communicate or be able to communicate with each other element. In some embodiments, not all depicted elements may communicate or be enabled to communicate with each other element.

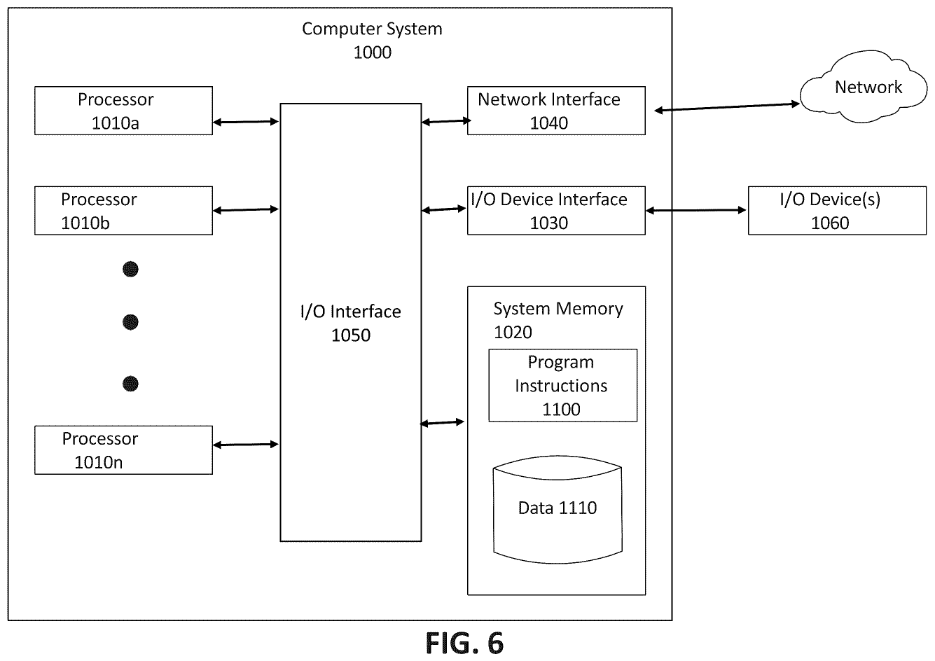

In some embodiments, the techniques described herein may be implemented within the computing environment 100 (e.g., including one or more of the illustrated components) shown in FIG. 1 by executing processes described herein upon computing devices like those described below and with reference to FIG. 6. In some embodiments, computing devices like those described with reference to FIG. 6 may include additional or other components specific to configurations discussed herein. Similarly, endpoints, server systems, repositories, and the like may include some additional or other components than those illustrated in FIG. 6. However, these devices may operate in accordance with principles similar to those discussed below and with reference to the computer device illustrated in FIG. 6, such as by loading instructions and other data into a memory and executing those instructions by a processor to perform various operations.

Referring back to FIG. 1, a plurality of endpoints (e.g., endpoints 120a-n) may be associated with a given entity, like a business or government, and the given entity may operate a server system (e.g., entity server system 110a). In some embodiments, the distinction between an entity server system and endpoints may be based on role rather than architecture or computing capabilities. For example, a plurality of servers may provide functionality consistent with other types of computing devices, like personal computing device type endpoints used by individuals, which in some examples may include virtualized computing devices (e.g., virtual machines) that are accessible by an individual via a client device (which may also be an endpoint) or otherwise provisioned (e.g., by a computing system) to provide a corresponding functionality.

In some embodiments, endpoints are computing devices (physical or virtual) known to corresponding entity systems, such as an entity server system, and may be used by employees of that entity. For example, an endpoint 120a may be an existing personal (or issued) computing device that is used to execute software products like an email client, one or more productivity applications (or access APIs thereof), web browsers, and the like, among other functions. For example, endpoint 120a may be used to access data like files stored locally or on a network drive, and that access may include requests by executing software products (e.g., to access data from a database). Examples of endpoints devices like 120a-n; 121a-n, and 122a-n may thus include, but are not limited to, desktop type computing devices, laptop or tablet type computing devices, virtual machines provisioned on computing devices and accessed by clients (which may also themselves be endpoints), mobile phones, Internet of Thing devices, and/or other computing device that execute software products. Examples of the techniques discussed herein and their use cases are often described within the context of endpoint computing devices (or virtual machines) running a desktop (or server) operating system (OS) with which users, like employees of an entity, commonly interact to perform their roles at the business or government entity. The use of such examples should not be taken to suggest that aspects of these techniques are not applicable to other example endpoint computing devices or use cases. Indeed, as these other types of endpoints proliferate and provide increased software utility (e.g., via third-party software) that increases exposure of entities (and even individual consumers) to risk from software vulnerabilities on such devices, those skilled in the art of the relevant fields of cybersecurity will recognize the extensibility of aspects of disclosed techniques to these other devices and alternative use cases in view of the present disclosure.

Embodiments of different endpoint devices, like endpoint device 120a, may execute a variety of different software products, examples of which may include both internally developed software 131 programs and/or third-party software 133 programs. Reference to internally developed software 131 programs should be not construed to suggest that such software programs cannot include or rely on any third-party or externally developed code or components, but rather is a reference to software programs or tools not typically available to other entities (e.g., via a software vendor). Oftentimes, while such software programs are developed internally, they frequently rely on open source or off the shelf components, libraries, code, and the like. Internal software 131 is often subject to less scrutiny than third-party software 133 made available by reputable vendors because evaluation solely depends on policies put in place by the entity. Some third-party software 133 that is executed by endpoints may also have little to no scrutiny, especially in the context of more permissible endpoint controls implemented by entities. For example, in many cases, an endpoint device 120a may obtain, install, and execute some third-party software 133 from one of a plurality of external software repositories 147. External software repositories 147 may include product websites of software developers 151, websites, and/or file servers that host compiled or uncompiled computer program code from a plurality of different software developers, and the like. Such external software repositories 147 often include software programs that are not vetted at all or by peer review of users. Such external software repositories 147 may be distinguished from trusted software repository/data 145 maintained by the entity server system 110a primarily in that software obtained via the trusted repository or vetted based on data stored therein (e.g., hash comparison of obtained data to trusted version of data) is reasonably assured to have not been tampered with by a malicious entity 105 after being made available or hash generated for an approved version. No such guarantees may be conferred for software obtained from an external source (or software that cannot be vetted).

As shown, the example computing environment 100 includes a plurality of entity server systems 110a, 110b, . . . 110n, each of which may correspond to a different entity, like a business or government. Entity server systems 110 may perform a variety of functions in support of associated endpoints. For example, an entity server system 110a may store trusted software that may be obtained by endpoints 120 or data for verifying permitted software that may be obtained by endpoints from other sources, like external repositories. In some embodiments, an entity server system may be tasked with obtaining permitted software or updates therefor from external software repositories 147 or vendors and vetting or verifying the obtained data prior to providing it to one or more associated endpoints. Entity server systems 110 may, in some embodiments, exert controls over associated endpoints. For example, each endpoint 120 associated with an entity server system 110a may be a device that is enrolled (e.g., by the entity server system) and may be permissioned to access certain resources within the context of a computing environment of the entity and from external sources. Some of those resources, like approved software and data from internal databases, among others, may be provided by the entity server system 110a while some other resources, like external databases and web applications, among others, may be accessed via external sources. In either case, access to at least some resources by an endpoint may be based on credentials that may be issued or revoked by the entity server system. For example, entity server system 110a may establish, issue, or verify credentials such that an employee may login to an endpoint 120a under a user account and access or use various resources under the user account based on the credentials. The entity server system 110a may revoke credentials to prevent access or use of resources by the endpoint, or access to a user account used on the endpoint by the employee, such as when an employee leaves the entity or if an endpoint device is lost/stolen/replaced.

In some examples, an entity server system, like entity server system 110a, includes trusted software repository/data 145. The repository/data 145 maintained by the entity server system 110a may be used to store (or store information about) approved software, software updates and patches, and the like that may be provided (e.g., pushed out or in response to a request) to endpoints (or used to verify approved software obtained from external sources). Such repositories/data may ensure that, at least in some cases, approved and trusted software is deployed among computing devices of the entity. Different entities may implement different policies with respect to employees obtaining, installing, and running software that is untrusted or unapproved.

Software developers 151 are depicted as legitimate actors that produce legitimate software which may be used by one or more of entities, endpoint users, and/or other consumers alike. Software developers 151 may develop software (e.g., software products) individually, in collaboration with others, or in connection with their employment with a software vendor. Such software products may be purchased or licensed by an entity and integrated with computing devices or existing software ecosystem of the entity by the developer, other vendor personnel, IT teams of the entity, and/or independent expert. Often, availability of such software on endpoints is directed (e.g., installed by default) or otherwise offered through an internal repository. Information for verifying the authenticity of such software may be maintained by the entity or other trusted party (e.g., developer or vendor) to ensure only legitimate versions of the software are used or accessed by computing systems associated with the entity.

Other externally, legitimately developed software products, as well as other external legitimate software in general, such as open source or off the shelf programs, components, libraries, code, and the like, may be obtained (whether trial, free, paid or open source) by individual or collections of employees for use on one or more endpoints, such as from an external software repository 147 or vendor. Software obtained in this fashion (even when approved) is typically subject to less stringent to non-existent oversight by the entity, IT teams, and controls for vetting software purchased by the entity directly. However, this does not inherently mean that any individual software product or component obtained in this fashion is riskier than some other software product or component. Indeed, software and IT professionals that are employees of entities and vendors alike often rely on external software repositories and open source programs, code, and the like to successfully perform functions of their employment. Accordingly, the benefits of permissive policies on use of software obtained from external software repositories 147 often outweighs the negatives on certain endpoints or for certain employees (which is not to suggest that risk does not exist, or may even be higher, but may be deemed acceptable in view of specific business tradeoffs). However, less sophisticated entities may not have other policy controls in place to restrict use by other employees and on other endpoints where risks of use of such software are a net negative (which is not to suggest that risk may not be low, but does not positively contribute to or align with entity business goals).

Malicious entities 105, in contrast to legitimate software developers 151, are depicted as potential threat actors that could attempt to exploit entities in different ways. One such way is through the development of malicious software or software components, which they may attempt to provide to endpoints via external software repositories 147 as standalone software (e.g., programs, tools, utilities), components of software (e.g., code, libraries, drivers, etc.), extensions that execute in the context of software runtime environments and the like. In some examples, the malicious entities 105 may alter existing, legitimate software, components thereof, and like, and make it available via an external software repository 147 to try and trick endpoint users into obtaining and using a malicious copy of the software in place of the legitimate software. Other examples include exploiting vulnerabilities of non-malicious software, where those exploits may be used to inspect or leak privileged data or credentials from memory, cause unsecure or unstable software or system behavior, supplant non-malicious code or processes with malicious ones, or cause software or systems to obtain and execute malicious code.

The depicted and other elements described herein may communicate with one another via a network 130, such as the Internet and various other local area networks, which is not to suggest that each element must communicate with each other element.

Some embodiments may improve endpoint security within the example computing environment 100 with techniques for analyzing the runtime behavior of one or both of internal software 131 and third-party software 133 on endpoints. Either type of software 131, 133 may be installed by user request or direction on an endpoint. Similarly, either type may be deployed by an entity server system on one or more endpoints. Neither type may be inherently more or less risky than the other, nor is the risk of certain software behavior equal in every context (e.g., different use cases, different execution environments, etc. and combinations thereof). Some embodiments may improve endpoint security without substantially altering permissive use policies with respect to developing or improving internal software 131 (that may be executed on one or more endpoints or other systems) based on or including software components, code, libraries, etc. obtained from external software repositories 147 or executing third-party software 133 products obtained from external software repositories. Specifically, because embodiments may analyze runtime behavior of software and respond to malicious behavior at runtime, the latency of response to software exploits and supply chain attacks may be reduced to a degree that obviates the risk to endpoints associated with such threats in many, or at least some, cases, among providing other benefits to threat intelligence operations.

In some embodiments, one or more endpoints associated with an entity, such as endpoint 120a, may execute an endpoint agent (not shown) to obtain information about the runtime behavior of software executed on the endpoint. Examples of an agent may include one or more computer program components, or modules, which are executed (or configured to be executed), such as in response to an instruction, call, or request for execution the agent. One or more of those computer program components may include computer program code defining one or more corresponding functions, which may be executed based on various criteria or conditions, and some of those functions may implement calls to execute other computer program components (e.g., of the agent) or to perform other functions based on other criteria or conditions. An agent executing on an endpoint may communicate with a server system (or multiple server systems), such as to report on endpoint activities. For example, embodiments of the agent may report information about software that is installed, attempted, or requested to be installed or uninstalled, or updated on the endpoint. Some or all such activity information may be reported contemporaneously to detection of the activity, e.g., event reporting.

In another example, embodiments of the agent may report information about the runtime behavior of software executed on the endpoint. Embodiments of the agent may perform selective monitoring to collect information about runtime behavior from some software but not other software. For example, an agent may monitor behavior of a subset (e.g., one or more) of programs that may be executed on an endpoint. In some examples, an agent may monitor behavior of only those programs that are selected (or positively identified) in the subset. In some examples, an agent may monitor behavior of detected programs that are not positively identified in a set of programs excluded from behavior monitoring. In some examples, an agent may detect an event corresponding to the installation of or attempt to execute a new program, report the event, and halt or pause one or more activities associated with the event until receiving an instruction (e.g., monitor, not monitor, or deny program execution) from a server system. In some examples, an agent may detect an event corresponding to the installation of or attempt to execute a new program, report the event, and monitor behavior of the program under first criteria until receiving an instruction from a server system to monitor behavior of the program under second criteria or not monitor behavior of the program. In some embodiments, the first criteria may be more restrictive of permissible program behavior than the second criteria (which is not to suggest that in some contexts the reverse may be true). The agent may generate a risk score for the program based on the runtime telemetry data. The risk score may be updated in response to changes in runtime behavior of the program over time.

Some embodiments of entity server systems may be used to orchestrate the deployment of such agents on managed computing devices, like some or all endpoints associated with the entity server system. For example, entity server system 110a may be used by an administrator or other IT professional to deploy agents on one or more endpoints (e.g., one or more of endpoints 120a-n) through software updates, updated images (e.g., for virtual machines, computing devices, containers, etc.), scripts causing the installation of agents, and the like. Additionally, entity server systems may provide instructions to managed endpoints or otherwise perform management operations responsive to information received from managed endpoints (e.g., via the agents executing on those managed endpoints). Instructions and management operations for any given managed endpoint or collection of managed endpoints may be determined based on information received from an agent executing on any one of those managed endpoints or any other managed endpoint. Thus, a plurality of endpoints associated with an entity server system may be configured to perform a client-side sole in endpoint protection, and the entity server system, another server system, or combination thereof may perform a server-side role in endpoint protection.

In some embodiments, a server-side role may include multiple different server systems that may perform different aspects of the server-side role. For example, in some embodiments, a server-side role may comprise multiple tiers of analysis that are performed by different servers or on different subsets of data. Entity server systems (or entities tenant accounts with an endpoint protect service provider) may, in some embodiments, perform a first tier of analysis, and another analytics system may perform a second tier of analysis on data collected from multiple different entity server systems or tenant accounts. In other words, in some embodiments, a third-party analysis service (e.g., which entities engage for services and which may be provided a vendor supporting entities use of endpoint agents) may receive (e.g., voluntarily or as a condition of obtaining analytics), for at least some software, information from one or more different entity server systems or respective tenant accounts, and that information may be or be based on information received by a respective entity server system from one or more managed endpoints that have previously, are currently, or are requesting to execute that software. Embodiments may employ entity server system reporting or entity tenant data isolation techniques to anonymize some or all identifying or sensitive entity data within the information prior to receipt by the third-party analytics service. In some embodiments, entity server systems or tenant accounts may at least partially anonymize or redact some data from the information and the third-party analytics service may further anonymize or redact some additional data from that provided in analytical reports.

In some embodiments, the third-party analysis service may detect an exploit or attack on software based on information received from a plurality of different entities with respect to that software. Some of those exploits or attacks may be more easily detected at the second analysis tier than, for example, the first analysis tier or by an agent examining behavior of a singular instance of the software on that endpoint. Similarly, some other exploits or attacks may be more easily detected at the first analysis tier than via behavior on a given endpoint or the second analysis tier; and some further other exploits or attacks may be more easily detected via behavior of an instance of software on a given endpoint than at the first or second analysis tiers. In some examples, one or more of analysis performed by an endpoint, at the first tier, or the second tier, are performed in real time, near real time, or otherwise temporally proximate to when at least some of the information on which the analysis is performed is collected by the endpoint.

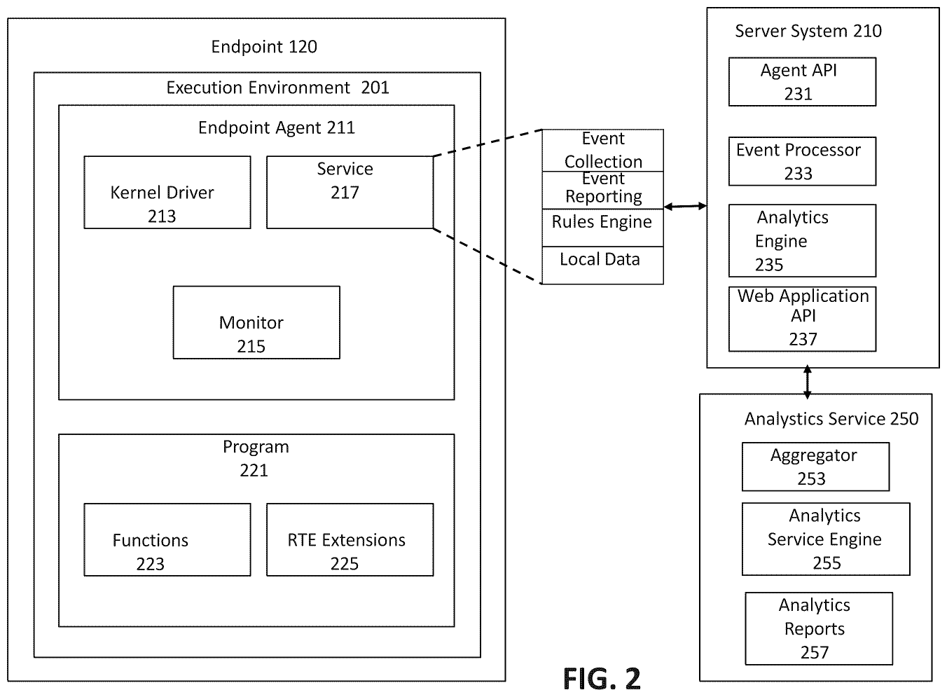

FIG. 2 is a diagram showing an example of a client-server architecture that may be used for assessing software executed on an example endpoint 120 at runtime within the example computing environment (e.g., 100 of FIG. 1), in accordance with at least some disclosed embodiments. FIG. 2 depicts an example endpoint 120, an example server system 210 (e.g., of an entity to which endpoint 120 corresponds) with which the endpoint (and other endpoints that are not shown) may communicate, and an analytics service 250 with which the server system 210 (and other server systems that are not shown) may communicate. As described with reference to FIG. 1, and elsewhere herein, embodiments and expected use cases may include tens, hundreds, thousands, or more different endpoints (some of which may perform a subset of the functionality or utilize a different configuration to provide similar functionality to that described with reference to FIG. 2). Similarly, while FIG. 2 depicts a single example server system 210, embodiments may include tens, hundreds, or more different server systems (some of which may perform a subset of the functionality or utilize a different configuration to provide similar functionality to that described with reference to FIG. 2). Additionally, as shown, some example embodiments may include a third-party analytics service 250, which may be implemented by one or more servers (e.g., similar to server system 210). The analytics service 250, in some examples, may provide cloud-based analytics services to a plurality of different entities (e.g., entities with a corresponding servicer system that reports information to the analytics service 250).

In some embodiments, endpoint 120 may be computing device that executes computer program code of an operating system to create an execution environment 201 within which other software runs (e.g., is executed). Example operating systems may include, but are not limited to, desktop-type and/or server-type operating systems like Windows-based and Unix or GNU/Linus-based operating systems, mobile-type operating systems like iOS and Android, and others. While some embodiments and components are described within the context of Windows-based operating systems, one skilled in the art would understand how the principles of the described techniques may be applied within the execution environments of other operating systems.

As shown, computer program code corresponding to an endpoint agent 211 may be executed by the endpoint 120. The endpoint agent 211 may run (e.g., execute) within the execution environment 201 along with one or more other programs, such as program 221. In some embodiments, the endpoint agent 211 includes component such as a kernel driver 213, service 217, and monitor 215 for performing various functionality ascribed to the endpoint agent. Some embodiments may distribute all or some functionality ascribed to the different components in different ways or may include fewer or additional components.

In some embodiments, such as to operate at a low, lowest, or privileged level within the execution environment 201, the endpoint agent 211 may include or interface with a component, like a driver. For example, the driver can be a kernel driver 213 in the context of a Windows-based environment, like an x64 Windows-based environment. In some embodiments, the kernel driver 213 is a software-only driver and handles I/O requests, but does not pass those requests to hardware.

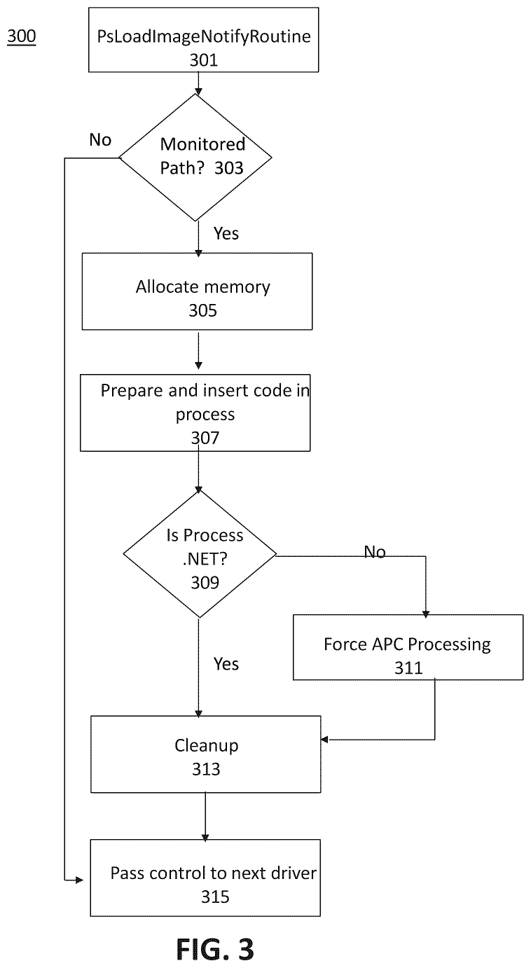

Turning briefly to FIG. 3, depicted is a diagram showing an example of a process 300 by which an endpoint agent may provision a monitor of a program process within the example computing environment, in accordance with at least some disclosed embodiments. In some embodiments, one or more components of the endpoint agent, like a kernel driver or service component, perform all or some of the depicted operations. In some examples, an endpoint agent on an endpoint comprises computer program code for a monitoring notification routine 301 that, when executed, monitors an execution environment of an operating system of the endpoint for the loading of software images, examples of which may include executable programs and other executable code or processes. In some examples, such as for Windows-based operating systems, the monitoring notification routine may use kernel callbacks to obtain a notification when an image is loaded or mapped to memory (e.g., system memory of the endpoint). In response to obtaining a notification and corresponding notification information, like a path or other information corresponding to the image, the endpoint agent may determine whether the notification information is indicative of an image associated with a program to be monitored 303, such as based on the path or other information. For example, a path may indicate a location of the image within a file system, and the endpoint agent may determine whether the path to the image matches or is included under a higher-level path (e.g., a folder or higher level in the file system or directory to which the image is resident) in a list of paths to monitor. At step 315, if the image is not identified as an image to be monitored, control may be passed, such as to a next driver. If an image, e.g., executable program code or program, is identified as an image to be monitored by the endpoint agent, the endpoint agent may allocate memory at step 305 (e.g., to a targeted program process) to which code may be loaded for execution in association with the program and then prepare and, at step 307, insert that code to the allocated memory for execution. For example, some embodiments may write into allocated memory a lightweight shellcode. After the code is inserted into memory of the targeted program process it may be executed. The code may include a function that includes information by which a monitoring component is called and executed. For example, the code may include a specified path to a monitoring component, like a DLL file comprising monitoring functions.

Some embodiments of an endpoint agent may utilize asynchronous calls (e.g., like an asynchronous procedure call (APC) within the context of a windows-based operating system) that execute asynchronously in context of a particular processing thread. When an APC is queued to a thread, a software interrupt is issued, and when the thread is next scheduled, the APC function is run. Other calls (e.g., asynchronous ones), interrupts, or other functions may be used to perform similar operations in embodiments implemented in the context of other operating systems. Some embodiments may perform additional or different operations for some processes. For example, in the context of a Windows-based operating system, some embodiments may handle .NET processes (which may include some (or none or all).NET Framework processes as .NET is a cross-platform framework and .NET Framework is Windows-based) differently from some other processes. As an example, in some embodiments, at step 311, APC processing may be forced for certain processes (e.g., non .NET processes) and not others (e.g., .NET processes). Embodiments of the process may then perform one or more cleanup 313 operations, such to free allocated memory 305, or other routines prior to passing control 315 on to the next driver.

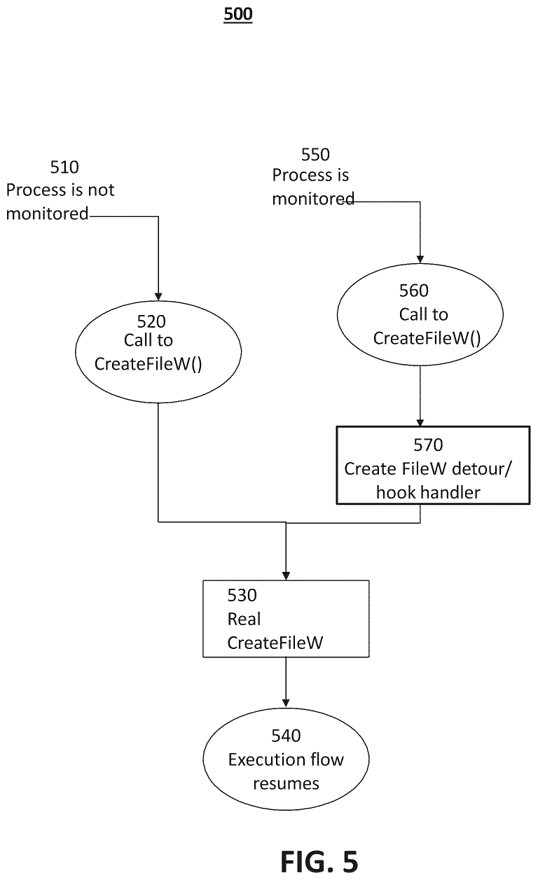

Turning briefly to FIG. 5, a diagram shows an example of a process 500 by which an endpoint agent may selectively monitor program processes, in accordance with at least some disclosed embodiments. In some embodiments, to monitor runtime processes behavior, such as within a window-based operating system, Microsoft Detours to hook/detour Windows API functions may be used. Detouring processes (also commonly known as hooking) may be applied dynamically at runtime right after monitor code (e.g., monitor DLL) has been loaded into the process to be monitored. In some embodiments, a monitoring component may be loaded and the loaded monitor may collect runtime telemetry, such as function calls, API activities, or other program behavior apt to include relevant and actionable information. In some embodiments, hook handlers determine whether a detectable event in runtime telemetry data, like a function or API call should be logged or not. If so, the event information may be forwarded to a service component for further processing, which may also receive event information from other monitors of other program processes. In some embodiments, processing within hook handlers is as minimal as possible in order to not slow down process execution. In some embodiments, parameters of function calls may be intercepted by the hook handler and sent to another thread that may perform any other configured operation on the information prior to passing it to the service component. For example, one or more data transforming or formatting operations may be performed, and in some examples, the information may be processed in accordance with one or more rules and criteria.

For example, as shown in FIG. 5, if a process is not to be monitored (e.g., determined at step 510), when the process invokes the Windows API function CreateFileW( ) to open or create a file at step 520, the process directly proceeds to execute the Real CreateFileW function as requested at step 530, and normal execution resumes at step 540. In contrast, if a process is to be monitored (e.g., determined at step 550), when the process invokes the Windows API function CreateFileW( ) to open or create a file at step 560, control is first passed to the detour/hook handler implemented by the agent at step 570. The detour/hook handler can log, analyze, or modify the original request. After any monitoring or security checks, at step 530, the hook handler calls the genuine CreateFileW function to perform the actual file operation (unless the handler blocks or alters the request). Finally, normal execution resumes at step 540.

Referring back to FIG. 2, in some example embodiments, a kernel driver 213 may provision one or more monitoring components at, during, or throughout runtime of a program 221 to monitor behavior of the program. In some embodiments, the kernel driver 213 uses kernel callbacks to determine when an image (e.g., corresponding to program 221) is loaded or mapped to memory. In other words, the kernel driver 213 may detect events pertaining to the execution of programs. In some embodiments, the kernel driver 213 may pass information about such detected events to a service 217 component.

In some embodiments, the kernel driver 213 stores, accesses, or is configured based on information (e.g., data in memory or storage on the endpoint), like identifiers, corresponding to a set of software programs that are to be monitored (or blocked or ignored). The kernel driver 213 may determine whether a detected event corresponds to a program (e.g., program 221) that is to be monitored (or not monitored or blocked) and report (e.g., to a service 217) an indication of whether the kernel driver monitored, blocked, or did not monitor the program for the event. Accordingly, in some embodiments, the kernel driver 213 may provision one or more monitors 215 to monitor the activities of program 221, such as in response to a determination (or determinations) to monitor those activities and may report information about those events.

In some embodiments, the kernel driver 213 may provision a monitor 215, like a monitoring engine, which is packaged as a dynamic-link library (DLL) or other code package. In some embodiments, to provision a monitor 215, like a monitor DLL, the kernel driver 213 writes (e.g., injects) code or instructions (e.g., for performing one or more functions) into memory associated with a targeted process (or processes). Thus, for example, to monitor activities of a program 221, embodiments of the kernel driver 213 may inject code or instructions (e.g., corresponding to a monitor 215 or to load a monitor component) into memory associated with a process (or processes) of the program that are to be executed by the execution environment 201.

In some embodiments, the code or instructions injected into memory (e.g., of a process of program 221) may be configured to (e.g., cause the execution environment 201 to) load (e.g., responsive to the execution of the injected code or instructions) a monitor 215 package, like a monitor DLL or other code package comprising monitoring functions to inspect program 221 behavior (e.g., at a low, lowest, or privileged level) via a process (or processes) of the program. In some embodiments, code or instructions are, or are included in, a lightweight shellcode that is injected into a targeted process memory. In some embodiments, the lightweight shellcode is a small piece of code used to load (e.g., from user space) the monitor 215, like a monitor DLL, for execution in connection with one or more processes of programs for which their runtime behavior within the execution environment is to be monitored.

In some embodiments, endpoint agent 211 (e.g., such by operations of a kernel driver 213) may cause, via injected code, a program 221 to call for the loading and execution of monitor 215 (e.g., executable code comprising one or more monitoring functions) which obtains information about program behavior. The monitor, when loaded by a program, may obtain and report out runtime telemetry data corresponding to program behavior, such as while the program is running. Examples of runtime telemetry data corresponding to program behavior may include, but are not limited to, information about function calls; data loaded, requested, or operated on by functions or processes of the program; system-level APIs, libraries, or services used or usage information; executable code or components loaded by the program; processes of the program; and the like.

Example embodiments of a monitor 215 consistent with configurations like those described above may include executable code that is loaded with respect to one or more processes of a program for which its behavior is to be monitored. In the context of some embodiments, such as within a Windows-based environment where monitor 215 is a DLL, the monitor may be a .DLL file including executable code that is not directly executed, but rather is loaded by another program (like the one that is being monitored) to execute functions of the DLL.

In some embodiments, as noted above, the kernel driver 213 may provision a monitor for (e.g., by injecting a monitoring DLL) targeted processes, where those targeted processes may be processes corresponding to or associated with a set of programs selected for monitoring. Processes corresponding to other programs (e.g., that are not selected for monitoring or are identified to a list of programs to not monitor) may be ignored by the kernel driver 213. In some embodiments, a list of monitored programs may include a list of paths (e.g., file paths) corresponding to (e.g., executable) software components, like one or more program files. In some embodiments, the list of monitored programs may be stored in a configuration file that may be accessed or used by one or more of the kernel driver 213 and service 217. Some examples of a configuration file may be a binary configuration file. In some embodiments, non-binary configuration files or various data structures can be used to store information (like paths) about programs selected for monitoring (or excluded from monitoring or that should be blocked) or other configuration information. Some examples of processes that may be excluded from monitoring, whether by default or explicitly, may include various protected processes, such as some processes of the operating system that are specific to or operate on some types of sensitive data, like credential values, or which when monitored could lead to unstable system behavior.

In some embodiments, a monitor 215 may implement one or more rules. In some embodiments, the one or more rules may include all or some of the rules that may be implemented by a rules engine in some example configurations. In some embodiments, the one or more r ules may include different rules than implemented by the rules engine. In some use cases, it may be preferred that a monitor be as lightweight (e.g., minimization of complexity, increased processing load, or increased latency) as possible. For example, no rules may be implemented by the monitor. Rather, the monitor may forward runtime telemetry data with little to no examination. In other example use cases, or as processing power (e.g., number of cores, threads, computational efficiency, etc.) of computing devices increase, it may be desired to implement a set of rules within or that may be called and loaded by monitor code. In some embodiments, a monitor 215 may analyze some or all collected runtime telemetry data to determine whether it satisfies criteria of one or more rules in the set of rules. In some embodiments, satisfying first criteria corresponds to detection of an event, and satisfying second criteria may correspond to detection of a different event, and different events may be handled in different ways. For example, some detected events may be responded to by one or more actions taken by the monitor (e.g., preventing or stopping execution of a program, process, or function) in addition to being reported out along with corresponding runtime telemetry data (e.g., to a service 217) while other detected events may be reported out as above but without the monitor taking specific action, and other components of the endpoint agent 211 may take action as described elsewhere herein.

In some examples, different rules may be applicable to some programs or processes (or types thereof) and not others or of higher priority to implement before others in some context, among other conditions or constraints. Some embodiments of an endpoint agent 211 may store a plurality of sets of rules or monitor instances that include a respective set, some of which may include different rules and may be associated with different programs or processes (or types thereof). In some embodiments, program or process specific rule sets may be lighter weight than alternatives and, as such, some examples may employ different monitor instances that include different rule sets or are otherwise configured with different rule sets when loaded for monitoring different programs. A data structure, like a lookup table, may be used to select a path of a monitor, configuration file, and/or rule set based on an identifier of a program or process detected by the kernel driver. Similarly, some embodiments of a rules engine that may be implemented with service 217 to analyze runtime telemetry data received from monitors may analyze some runtime telemetry data that corresponds to different programs or processes (or types thereof) with different sets of rules at least for reasons similar to those described above.

Like the endpoint agent 211, program 221 may be configured to perform one or more functions 223 during execution. Example programs may comprise machine-level instructions, bytecode, or any other code format suitable for execution by a processing unit of an endpoint device 120, examples of which include program 221 and endpoint agent 211. When a program is to be executed on an endpoint 120, executable code and associated data can be loaded into memory (e.g., that is allocated by the execution environment). For example, an execution environment 201 may load a program code into memory and initialize the program by setting up a runtime context with memory allocated to program variables, setting up a call stack, and loading any required libraries, dependencies, or runtime components that are used by the program 221 operation. In some embodiments, a runtime context ensures that necessary resources are available and that the program has access to the appropriate system-level APIs, libraries, and services required for its execution. Some example embodiments of endpoint agents 211 described herein may cause a monitor to be loaded within the runtime context for a program within an execution environment. For example, a library file, like a DLL, including monitor code may be loaded, and embodiments may use various techniques to cause that library file to be loaded (e.g., code injection to cause the library to be loaded).

During execution, a program 221 may perform various operations and use various functions to perform its ascribed functionality (e.g., program functions 223), such as reading from or writing to memory, making system calls, interacting with input/output devices, or communicating with other software components or services. A monitor may detect/track/inspect/identify/etc. instances of these and other program activities during execution to collect associated runtime information e.g., telemetry data, which may include information about the variables, targets, data, etc. pertaining to corresponding program activities. In some embodiments, an execution environment 201 may provide controlled access to these operations functions, ensuring that the program adheres to predefined security policies and access controls. For example, an execution environment 201 may implement sandboxing techniques to isolate a program from other processes or restrict its access to specific resources. Embodiments of techniques that cause a monitor to be loaded within the runtime context of a program may thus be afforded better visibility into program activities than other techniques which may be prohibited from inspecting those activities.

In some embodiments a, monitor may include a filter or rules (which may be hardcoded within the monitor code) to identify certain events and corresponding telemetry data that are of interest to report out. In other words, in some embodiments, a monitor need not be tasked with collecting and reporting out all possible telemetry data from all possible activities to which the monitor may have visibility (which is not to suggest that such operation is not disclaimed, but rather there may be performance and risk tradeoffs). Embodiments of a monitor may report out data, such as event and telemetry data, while the program is executing, e.g., at runtime.

Additionally, in some examples, a program 221 may provide, configure, interface with, or otherwise communicate with a software (e.g., virtual) runtime environment (not shown) to run other (typically lightweight) pieces of software during program runtime, like extensions (e.g., program 221 runtime environment (RTE) extension 225), macros, scripts, etc., within the context of the program. A virtual runtime environment may thus be provided by a program (or another program or framework) that is executed within the execution environment 201. Some embodiments of an endpoint agent 211 may include one or more RTE monitors (not shown) that may be executed within such a runtime environment. A different RTE monitor may be included for each different virtual runtime environment within which operations (e.g., of corresponding RTE extensions 225) are to be monitored. Some embodiments may configure these environments, such as with a script, or code injection to the corresponding program or framework, to execute a corresponding RTE monitor by which activities of code (like RTE Extensions 225) executed therein may be monitored.

In some embodiments, a service 217 component stores, updates, or transmits information (e.g., data in memory or storage on the endpoint) like that described herein in association with endpoint agent 211 functionality (e.g., in reference to the agent 211 or various ones of its components). For example, the service 217 may store, update, and collect information about reported events that were detected by the kernel driver 213, as well as information about events (which may include program behavior) detected by a monitor 215, as well as events that may be detected by the service 217 or other components (not shown). The service 217 component may report on one or more events detected on the endpoint 120 and other information to a server system 210. The service 217 may receive data from the server system 210, such as instructions, commands, new/updated configuration or rules information, or other data described herein, such as in response to reported events and their associated data or other information.

In some embodiment, service 217 component creates a named pipe to which a monitor instance can forward collected program runtime behavior information. In some embodiments, multiple pipes may be created, such as for collecting information from different programs. In some embodiments, multiple monitor instances may forward their collected runtime behavior information to a single named pipe (which it not to suggest there cannot be more than pipe). In some embodiments, the service 217 component may store information received from monitors in a local SQLite database, and may optionally perform one or data formatting or filtering operations prior to storage. For example, the service 217 may store some portion of collected data in response to detection of an event (or event to which that portion of collected data is deemed pertinent) and otherwise discard that portion of collected data. The service 217 component may also use the database to track event reporting to avoid duplicative reporting or otherwise manage event reporting, such as to batch report some events and forward others to a server system upon receipt or detection.

In some embodiments, the service 217 may transmit data about programs on the endpoint 120 that are or may be executed within the execution environment 201. In some embodiments, the service 217 receives data about one or more programs that are to be monitored by the endpoint agent 211 and may store or update local data or other endpoint agent 211 data to cause the endpoint agent 211 to monitor behavior of the one or more programs while they are running (e.g., executing) within the execution environment 201.

In some embodiments, the service 217 may include a rules engine by which information about program behavior and detected events may be analyzed. In some embodiments, a rules engine may be used to analyze runtime telemetry data that is being reported to the service 217 by one or more monitor instances currently reporting monitored program behavior. Some embodiments of rule engines may also consider previously reported monitored program behavior, like with a sliding window approach, which may consider a slice of telemetry data extending back or forward from, or around a selected inspection point for a given ordering of program behaviors (e.g., by timestamps associated with respective operations, linked list of operations based on dependencies, or other ordering) reported in telemetry data. Some embodiments may apply one or more filters to collected telemetry data to select a subset of telemetry data (e.g., based on one or more factors described herein, like by program or process, duration in time or number of data points, etc.) for analysis. After the selected inspection point is analyzed, a next selection point may be selected, which may be a next adjacent data point, or may skip one or more data points (e.g., based on a desired degree of data point overlap between successive windows). Some embodiments of a rules engine may be used to detect instances of malicious activity, an exploit of a program, or attack on a program or endpoint that may transpire differently in time than operation space, such as by using different widths of windows for different types of orderings upon different subsets of telemetry data selected with filtering criteria that are expected to improve detections. For example, a program may be exploited at a first time to leak credential values from system memory to a file stored locally on the system. Then, at a second time, the file or information therein may be transmitted by the program to a malicious actor. Depending on credential values at issue, the duration between the first time and the section time may be more or less important. Consider a social security number that may be relevant for many decades in contrast to a one-time-password or encryption key that may expire, be discarded, or rotated in less than a day, hour, minute, or less. In the case of the social security number example, an ordering of events in operation space that target the file may be concise (<file stored>, <file read>), whereas in time, the stored and read event may be days, weeks, months, or years apart without any substantial change in risk. In contrast, a one-time-password or symmetrical encryption key, e.g., for a session between two computing devices, may only be damaging if an attacker is able to access the file while the session is active. Here, an ordering of events in time space may prove much more relevant: the file stored and file read operations generally must occur near each other in time for a malicious actor to obtain harmful data.

Embodiments of the rules engine may include all or some of the rules or provide all or some of the functionality described elsewhere herein, such as with respect to the monitor, and may provide additional or different functionality (which is not to suggest that such additional or different functionality cannot be divided among different components of an endpoint agent in different ways). Embodiments of service 217 components that implement a rules engine may be subject to all or some of the constraints described with respect to implementing some rules with monitor components. In other words, some use cases, like those that are latency sensitive or computing resource limited, may lend themselves to tradeoffs like use of a lighter weight rule set (or sets)/rules engine, or even none at all. Indeed, some embodiments of a service 217 may perform none, a minimal, or limited amount of processing on the endpoint 120 for one or more detected events (or types thereof) or of runtime telemetry data for one or more programs (or types thereof), and embodiments may leverage one or more server systems to perform some or all of that processing. In turn, the service 217 may receive instructions, rules, or updates from a server system 210 based on one or more analyses performed by the server system 210, analytics server 250, or combination thereof.

Embodiments of the service 217 or other component of the endpoint agent 211 may implement one or more hardening features to mitigate attacks on the agent. For example, the service 217 may monitor registry and filesystem activities using one or more rules or filters to detect activities targeting one or more of its file paths, files, and registry keys or other program data associated with the endpoint agent.

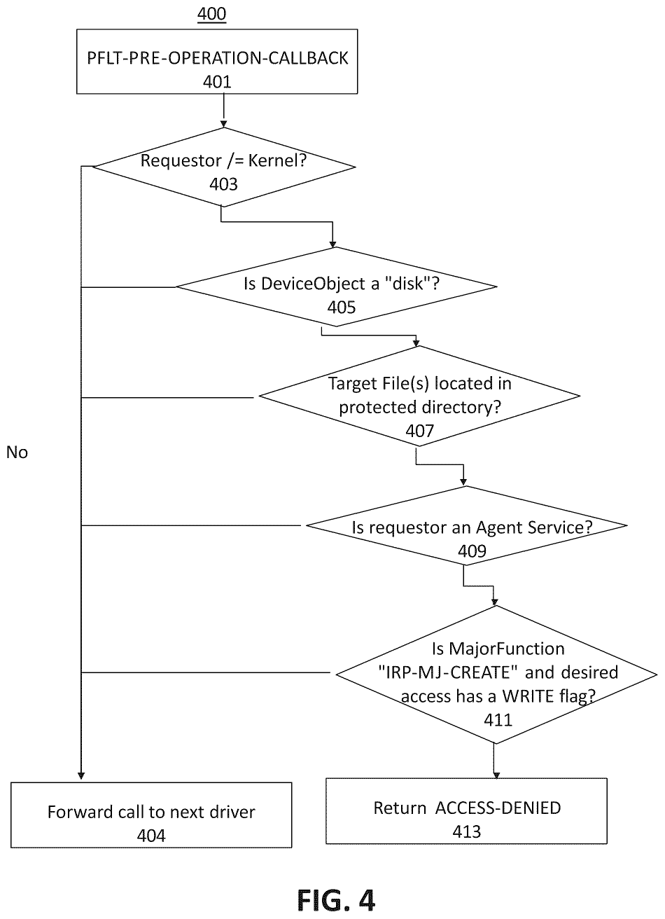

Turning briefly to FIG. 4, an example process 400 for hardening some example embodiments of endpoints agents descried herein is shown. In some embodiments, one or more components of an endpoint agent 211, like a kernel driver or service component, may perform all or some of the depicted operations, e.g., elements 403-411, in response to a callback operation 401 to determine whether to deny access at step 413 (e.g., to files of the endpoint agent 211) or forward the call to the next driver at step 404.

At step 401, the kernel driver can receive a pre-operation callback for a file system request. This is an opportunity to inspect or modify the request before it is processed by the file system. At step 403, the process checks whether the requestor (the entity making the request) is not the kernel driver itself. If the request does originate from the kernel driver, the process proceeds to step 404, and the call is forwarded to the next driver. If the request does not originate from the kernel driver, further checks are performed, and the process moves to step 405. At step 405, the process verifies whether the target device object for the request is a disk (as opposed to, for example, a network or other device type). If the target device object is not a disk, the process proceeds to step 404, and the call is forwarded to the next driver. If the target device object is a disk, further checks are performed, and the process moves to step 407. At step 407, the process checks if the file(s) being accessed are located within a protected directory. If the file(s) are not in a protected directory, the process proceeds to step 404, and the call is forwarded to the next driver. If the file(s) are in a protected directory, further checks are performed, and the process moves to step 409. At step 409, the process determines whether the requestor is the agent service itself. If the request is not from the agent service, the process proceeds to step 404, and the call is forwarded to the next driver. If the request is from the agent service, the process continues to the next check at step 411. At step 411, the process checks if the operation is a file creation/open request and whether the request includes a write access flag (indicating an attempt to write to the file). If not, the process proceeds to step 404, and the call is forwarded to the next driver. If all above conditions are met, the driver denies the request by returning an access denied status, preventing the file from being created or opened for writing at step 413.

Referring back to FIG. 2, in some example embodiments, a server system 210 may perform a server-side role in support of a plurality of endpoints, an example of an instance thereof being endpoint 120. The sever system 210 may receive event and program behavioral data (e.g., runtime telemetry data) from a plurality of different endpoints for a plurality of programs. For example, the server system 210 may include an agent API 231 by which managed endpoints communicate with the server system. For example, embodiments of endpoint agents may report event data, request updates, establish heartbeats, and otherwise communicate with the server system 210 via the agent API 231 to register/report status with the server system 210, receive requested information, like updates, and other functions described herein. Some examples embodiments of a server system 210 may include one or more components such as an event processor 233, analytics engine 235, and a web application API 237, each of which may perform corresponding functions described below or other relevant functions described herein.

In some embodiments, an event processor 233 may determine actions based on an event or events received from an endpoint or multiple endpoints, and those actions may be applied to the endpoint, a different endpoint, or all or some of the endpoints. Some example actions may include, but are not limited to, generating a notification or reporting data which may be pushed to one or more of an administrator of the server system 210, an analytics service 250, or endpoint 120 (or endpoint user, such as via the endpoint, an account of the user, or a secondary device associated with the user). Some example actions may include management actions (e.g., like locking, blocking, or terminating, and others described herein) that may be taken with respect to an endpoint 120, a program 221 on the endpoint, or account of a user associated with the endpoint. Some other example actions may include management actions to update or otherwise configurate operation of one or more endpoint agents 211. Embodiments may identify collections of endpoints to which an action or actions is to be applied based on one or more of a variety of factors that may be known to the server system 210. For example, as endpoint agents 211 may report which programs are installed on which endpoints, and other specifics pertaining to those programs, like current version, last version, versions of different executable code used by the programs, file paths, among other information, filter criteria may be applied to a database (not shown) storing that information to identify a collection of endpoints matching various endpoint, endpoint execution environment, and program criteria. In some embodiments, the event processor 233 may parse the information associated with a detected event and determine a selection of relevant filter criteria (e.g., procedurally, using an off the shelf large language model, or one of a variety of commercially relevant types of machine learning models (including LLMs, neural networks, etc.) or classifiers, alone or in combination with other techniques, that may be trained to perform selections of filter criteria that minimize error in identification of at risk systems to the collection for action).

In some embodiments, an analytics engine 235 performs one or more of the analytical processes to determine results like those described herein with reference to entity and customer systems based on data received from various managed endpoint devices, of which endpoint 120 is one such example, and that which may be received from an analytics service 250. In some embodiments, the analytics engine 235 may provide all or some of the results or information it determines based on data reported by the endpoints it manages. In some examples, some portions of the information reported to the service 250 may be anonymized or redacted. The analytics engine 235 may also determine, such as based on unredacted data (that is not proved to the analytics service 250) and processing results received from the analytics service, additional entity-specific results based on data reported to the service by other entities (which may too have been redacted, but strikes an advantageous result for participant entities that does not involve sharing sensitive data with other entities or the service 250).

In some embodiments, a web application API 237 may respond to requests for data like that described herein, such as for presentation to an administrator via a web application by which the administrator may view results and information like that described herein with respect to an entity and managed endpoints. The web application API 237 may additionally respond to requests for information received by the server system 210 from an analytics service 250, in addition to requests for entity-specific results based on data reported to the service 250, like that described above. The web application API 237 may also receive instructions, commands, selections, or other input by administrators into a corresponding web application interface, such as for managing endpoints in one or more of the various ways described herein.

In some embodiments, an analytics service 250 may receive a variety of unredacted, redacted, filtered or raw telemetry, event, or entity analytic results data from computing systems (e.g., similar to server system 210) that operated by various different entities. In some embodiments, the service 250 includes an aggregator 253 to combine, normalize, redact, or otherwise pre-process data received from entity server systems prior to performing one or more analyses that are often carried out by the analytics service engine 255 on data obtained from a plurality of entities. In many cases, entity server systems may not be permitted to obtain the breadth of different entity data available to the analytics service. Moreover, even if the entirety of data obtained by a 3^{rd} party analytics service was made available to an entity server system, it may prove too costly in time, processing power, or developer time to operate on the dataset. Accordingly, embodiments contemplate the generation of various analytics reports 257 by the analytics service engine 255, whether in a periodic distribution format (e.g., providing results and some or all of the underlying data in a dataset), request and response, or combination thereof. In either case, it is expected in some embodiments that at least some analytics server data obtained from a plurality of entities may be made available to the server systems 210 of those entities to facilitate additional analyses using their respective unredacted data to determine deeper insights than might otherwise be possible.

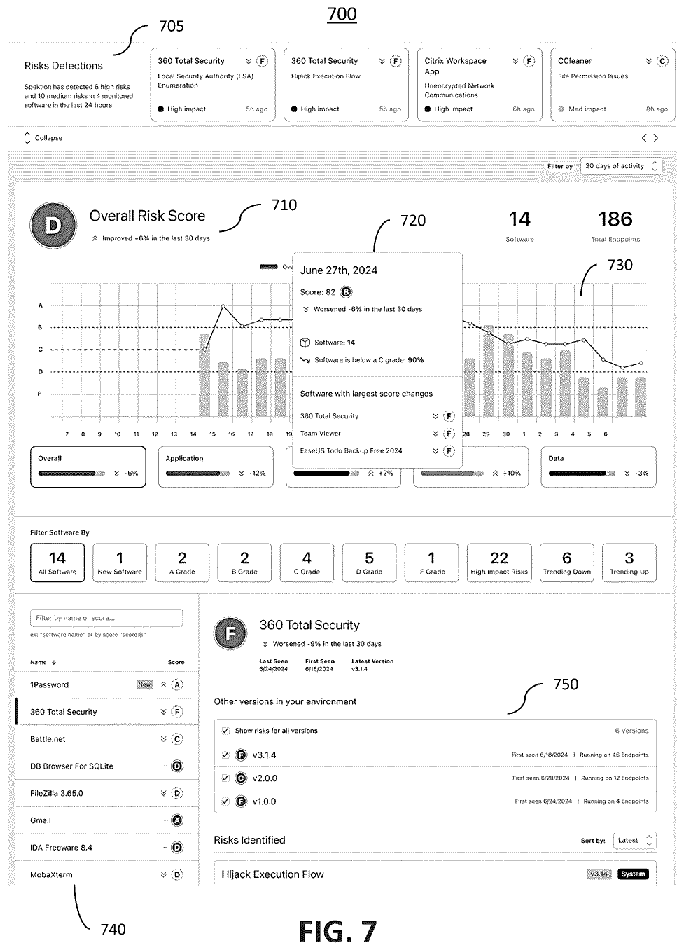

FIG. 7 is an example embodiment of a user interface 700 by which some examples of results and information may be displayed. For example, the user interface can display vulnerability/risk scores of different programs that may be determined based on respective runtime telemetry data among other factors like execution context in accordance with at least some embodiments of the techniques disclosed herein. As shown in FIG. 7, the user interface 700 can include a risk detections summary 705, showing an overview of programs with detected risks, a summary of the detected behavior indicative of the risk, and the impact of each risk. The user interface 700 can also include an overall risk score panel 710, which can comprise a visual representation of overall risk score 730 over time. The visual representation of overall risk score can be interactable. For example, if a user selects, hovers over, or otherwise indicates a point in time, a summary 720 of the overall risk at that point in time can be displayed. The user interface 700 can also include a list of software applications 740. The list of software applications 740 can also be interactable. For example, if a user selects a software application of the list of applications, the user interface can display details about that selected software application in pane 750. Such details may include trends in time, version histories, scan histories, and/or risks identified.

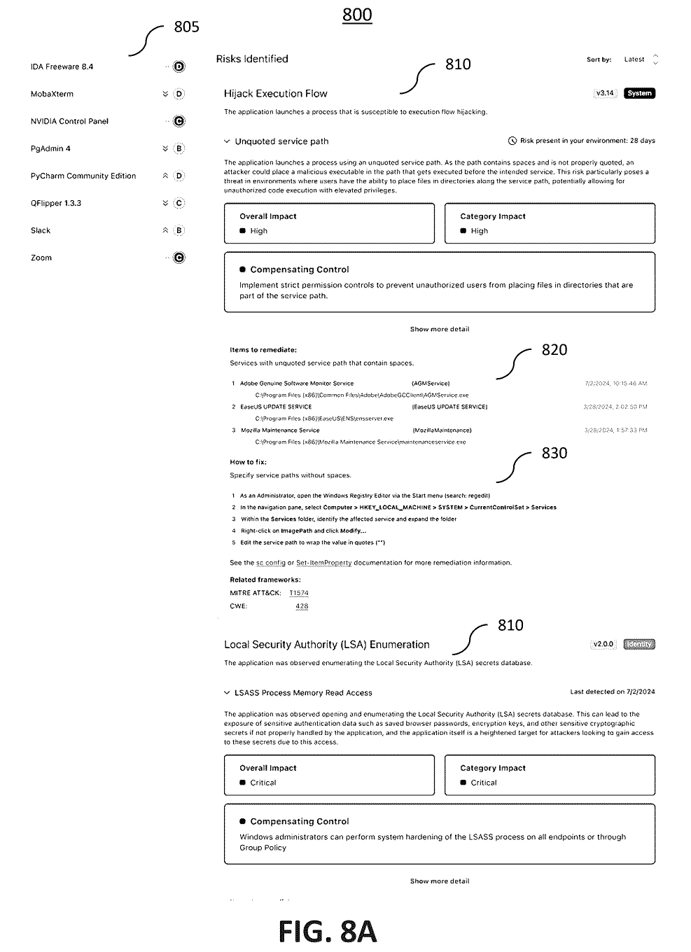

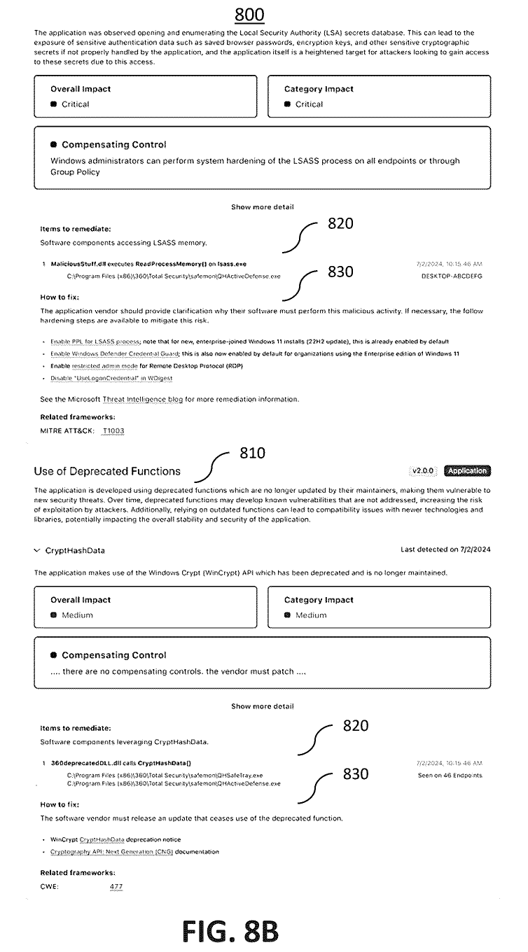

Shown in FIGS. 8A and 8B are additional example embodiments of a user interface 800 by which some examples of results and information determined in accordance with the present techniques may be displayed. Some embodiments of example user interfaces may include one or more expandable or drop-down menus 805 by which risks/vulnerabilities identified in a corresponding (e.g., selected) program based on monitored behavior of that program may be displayed. Some embodiments of example user interfaces may display information 810 describing specific program behaviors and their associated security risks that caused an embodiment of the present techniques to detect a risk/vulnerability in runtime telemetry data of the program. Some embodiments may also determine and display one or more potential compensating controls, recommendations for remedial actions 820, and recommendations for fixes 830 in association with respective identified risks/vulnerabilities identified in a program.

Some embodiments may employ a large language model to determine prose, pseudocode, or code based on a request prompt (e.g., for a prose description, pseudocode example, or software code) and one or more identified risks/vulnerabilities, determined scores, detected events, and program behavior/telemetry data. In some embodiments, one or more of identified risks/vulnerabilities, determined scores, detected events, and program behavior/telemetry data or other results determined in accordance with embodiments of the present techniques may be stored in a database in addition to later results by which one or more trends may be determined and by which changes in risk as a response of a customer or entity to mitigating identified security risks/vulnerabilities by implementing proposed or other compensating controls, fixes, etc. of one or more programs may be determined. Additionally, such data may be used in one or more training data sets to fine-tune a baseline large language model based on event/runtime telemetry data training data sets to enrich or improve model output and improve customer or entity response rate to or latency to implementing risk mitigation solution.

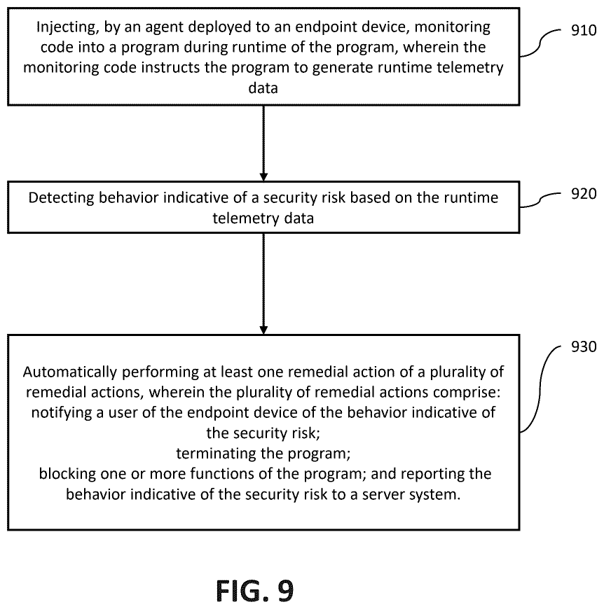

FIG. 9 is a flowchart of an example method for a method for providing endpoint security. At step 910, the method comprises injecting, by an agent deployed to an endpoint device, monitoring code into a program during runtime of the program, wherein the monitoring code instructs the program to generate runtime telemetry data. At step 920, the method comprises detecting behavior indicative of a security risk based on the runtime telemetry data. At step 930, the method comprises automatically performing at least one remedial action of a plurality of remedial actions. The plurality of remedial actions includes: notifying a user of the endpoint device of the behavior indicative of the security risk, terminating the program, blocking one or more functions of the program, and reporting the behavior indicative of the security risk to a server system.

FIG. 6 is a diagram that illustrates an example of a computing system 1000 in accordance with embodiments of the techniques described herein. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to a system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multi-processor systems may include multiple processors (e.g., chiplets) on a single physical processor, multiple physical processors, or multiple instances of various ones of components of computing system 1000. Multiple processors or cores of a processor may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable (e.g., a computer-readable) storage device, a machine readable storage substrate, a memory device, or any combination thereof. A non-transitory computer-readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer-readable storage medium that may have program instructions stored thereon that are executable by a computer processor (e.g., one or more of processors 1010a-1010n) to cause the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer-readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. The distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include,” “including,” and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square,” “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first,” “second,” “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively.

In this patent, where certain U.S. patents, U.S. patent applications, or other materials (e.g., articles) have been incorporated by reference, the contents (e.g., text, images, etc.) of such U.S. patents, U.S. patent applications, and other materials is, however, only incorporated by reference to the extent that no conflict exists between such content and the statements and drawings set forth herein. In the event of such conflict, the text of the present document governs, and terms in this document should not be given a narrower reading in virtue of the way in which those terms are used in those U.S. patents, U.S. patent applications, or other materials that have been incorporated by reference.

### Exemplary Embodiments

Example claimable subject matter includes, but is not limited to:

A. An embodiment of a computer implemented process or method comprising operations for improving endpoint security in accordance with one or more of the techniques described herein.

B. An embodiment of a computer implemented process or method comprising operations for obtaining runtime telemetry data indicative of software behavior to improve endpoint security.

C. An embodiment of a computer implemented process or method comprising operations for providing a client-side monitoring component, or agent, to an endpoint, the agent performing a client-side role in improving endpoint security.

D. An embodiment of a computer implemented process or method comprising operations for analyzing runtime software behavior on an endpoint with a client-side monitoring component, or agent.

E. An embodiment of a computer implemented process or method comprising operations for software behavior analysis performed by a server system in support of endpoint devices.

F. An embodiment of a tangible, non-transitory machine readable medium storing instructions that when executed by one or more processors effectuate functionality corresponding to any one of the embodiments described above.

G. An embodiment of a system (e.g., a computing system) for implementing any one of the embodiments described above.

1. A method for providing endpoint security, the method comprising:
injecting, by an agent deployed to an endpoint device, a monitoring code into a program during runtime of the program, wherein the monitoring code instructs the program to generate runtime telemetry data;
detecting behavior indicative of a security risk based on the runtime telemetry data; and
automatically performing at least one remedial action of a plurality of remedial actions, wherein the plurality of remedial actions comprise:
notifying a user of the endpoint device of the behavior indicative of the security risk;
terminating the program;
blocking one or more functions of the program; and
reporting the behavior indicative of the security risk to a server system.

2. The method of claim 1, further comprising transmitting, by the agent, the runtime telemetry data to the server system.

3. The method of claim 1, wherein injecting the monitoring code comprises allocating memory within the program and installing the monitoring code in the allocated memory.

4. The method of claim 3, further comprising freeing the memory within the program after the monitoring code has been executed.

5. The method of claim 1, wherein the agent selectively monitors the program based on a list of monitored programs stored on the endpoint device.

6. The method of claim 1, wherein the agent injects the monitoring code into the program in response to detecting a predetermined event associated with the program.

7. The method of claim 6, wherein the predetermined event comprises a launch or installation of the program.

8. The method of claim 1, wherein detecting the behavior indicative of the security risk comprises applying a set of rules to the runtime telemetry data.

9. The method of claim 8, wherein the agent updates the set of rules based on instructions received from at least one of the server system or the user of the endpoint device.

10. The method of claim 1, wherein the behavior indicative of the security risk corresponds to at least one of unauthorized access attempts, unauthorized communication attempts, installation of software, or removal of software.

11. The method of claim 1, wherein detecting the behavior indicative of the security risk comprises analyzing the runtime telemetry data within a selected time window.

12. The method of claim 1, wherein the agent at least partially anonymizes the runtime telemetry data prior to reporting the behavior indicative of the security risk to the server system.

13. The method of claim 1, wherein the agent continuously monitors the program for changes in runtime behavior over time.

14. The method of claim 1, further comprising displaying, via a user interface, information describing the behavior indicative of the security risk.

15. The method of claim 14, wherein the user interface is further configured to display recommended remedial actions or compensating controls associated with the behavior indicative of the security risk.

16. The method of claim 1, further comprising generating a risk score for the program based on the runtime telemetry data.

17. The method of claim 16, wherein the risk score generated for the program is updated in response to changes in runtime behavior of the program over time.

18. The method of claim 1, wherein the runtime telemetry data comprises at least one of: information about function calls executed by the program; data loaded, requested, or operated on by functions or processes of the program; system-level APIs, libraries, or services used by the program; executable code or components loaded by the program; and processes of the program.

19. A system for providing endpoint security, comprising:
one or more processors; one or more memories; and one or more programs, wherein the one or more programs are stored in the one or more memories and configured to be executed by the one or more processors, the one or more programs including instructions for:
injecting, by an agent deployed to an endpoint device, a monitoring code into a program during runtime of the program, wherein the monitoring code instructs the program to generate runtime telemetry data;
detecting behavior indicative of a security risk based on the runtime telemetry data; and
automatically performing at least one remedial action of a plurality of remedial actions, wherein the plurality of remedial actions comprise:
notifying a user of the endpoint device of the behavior indicative of the security risk;
terminating the program;
blocking one or more functions of the program; and
reporting the behavior indicative of the security risk to a server system.

20. A non-transitory computer-readable storage medium storing one or more programs for providing endpoint security, the one or more programs comprising instructions, which when executed by one or more processors of an endpoint device, cause the endpoint device to:
inject, by an agent deployed to the endpoint device, a monitoring code into a program during runtime of the program, wherein the monitoring code instructs the program to generate runtime telemetry data;
detect behavior indicative of a security risk based on the runtime telemetry data; and
automatically perform at least one remedial action of a plurality of remedial actions, wherein the plurality of remedial actions comprise:
notifying a user of the endpoint device of the behavior indicative of the security risk;
terminating the program;
blocking one or more functions of the program; and
reporting the behavior indicative of the security risk to a server system.
